(19) United States
(12) Patent Application Publication
(10) Pub. No.: US 2025/0139352 A1
(43) Pub. Date: May 1, 2025

(54) TASK PROCESSING METHOD AND APPARATUS, ELECTRONIC DEVICE, AND COMPUTER-READABLE STORAGE MEDIUM

(71) Applicant: Beijing Zitiao Network Technology Co., Ltd., Beijing (CN)

(72) Inventors: Danni WU, Beijing (CN); Yongning FU, Beijing (CN)

(21) Appl. No.: 18/837,177

(22) PCT Filed: Feb. 8, 2023
(86) PCT No.: PCT/CN2023/075037

§ 371 Date: Aug. 8, 2024

(30) Foreign Application Priority Data
Feb. 9, 2022 (CN) 202210122506.4

(51) Int. Cl. G06F 40/166; H04L 51/046

(52) U.S. Cl. CPC G06F 40/166; H04L 51/046

(57) ABSTRACT

The disclosure provides a method and apparatus for processing a task, an electronic device, and a computer-readable storage medium. The method includes: receiving editing information of a target task transmitted by a client of a first service type, wherein the editing information of the target task includes: index information of the target task and editing data for modifying the target task; determining a client of a second service type containing the target task according to the index information of the target task; transmitting the editing information of the target task to the client of the second service type to cause the client of the second service type to synchronously modify the target task; and similarly, transmitting, in response to receiving editing information of a target task transmitted by the client of the second service type, the editing information of the target task to the client of the first service type to cause the client of the first service type to synchronously modify the target task.

### CROSS-REFERENCE TO RELATED APPLICATION(S)

The disclosure claims the priority to Chinese Patent Application No.202210122506.4, filed on Feb. 9, 2022, and entitled “Method and apparatus for processing a task, electronic device, computer-readable storage medium”, which is incorporated in its entirety herein by reference.

### FIELD

The disclosure relates to the technical field of computers, and particularly relates to a task processing method and apparatus, an electronic device, and a computer-readable storage medium.

### BACKGROUND

As instant messaging tools grow, their function is no longer limited to transmitting instant messages. They are gradually integrated into a variety of office application products, which become collaborative work platforms. For instance, many collaborative work platforms integrate instant messaging applications, online documents, mailboxes, etc. The online documents herein are cloud documents.

In related art, tasks can be created in the instant messaging applications, so as to assist users in recording and planning work progress. In addition, the online document is used as an efficient carrier of collaborative work content, in which the user can create a task. However, tasks of the same user are scattered in the online document and the instant messaging application, which are inconvenient to manage and cause a lot of inconvenience to the user.

### SUMMARY

The disclosure provides a task processing method and apparatus, an electronic device, and a computer-readable storage medium, such that a document can be synchronized with task content data of a task center, so as to facilitate task management of a user.

In a first aspect, the disclosure provides a task processing method. The method includes:
receiving editing information of a target task transmitted by a client of a first service type, where the editing information of the target task includes: index information of the target task and editing data for modifying the target task;
determining a client of a second service type containing the target task according to the index information of the target task;
transmitting the editing information of the target task to the client of the second service type to cause the client of the second service type to synchronously modify the target task; andwh
similarly, transmitting, in response to receiving editing information of a target task transmitted by the client of the second service type, the editing information of the target task to the client of the first service type to cause the client of the first service type to synchronously modify the target task.

In a second aspect, the disclosure provides a task processing method. The method includes:
transmitting, in response to an opening request for a document of a client of a first service type, a first data obtaining request to a task server, where the first data obtaining request includes: index information of a target task corresponding to a task type document block in the document;
receiving a first data obtaining response transmitted by the task server, where the first data obtaining response includes: task content data corresponding to the index information of the target task; and
displaying, on the basis of the task content data corresponding to the index information of the target task, the task content data at a position of the task type document block in the document.

In a third aspect, an example of the disclosure provides an apparatus for processing a task. The apparatus includes:
a reception module configured to receive editing information of a target task transmitted by a client of a first service type, where the editing information of the target task includes: index information of the target task and editing data for modifying the target task;
a determination module configured to determine a client of a second service type containing the target task according to the index information of the target task; and
a transmission module configured to transmit the editing information of the target task to the client of the second service type to cause the client of the second service type synchronously modifies the target task; and configured to transmit, in response to receiving editing information of a target task transmitted by the client of the second service type, the editing information of the target task to the client of the first service type to cause the client of the first service type to synchronously modify the target task.

In a fourth aspect, an example of the disclosure provides an apparatus for processing a task. The apparatus includes:
a transmission module configured to transmit, in response to an opening request for a document of a client of a first service type, a first data obtaining request to a task server, where the first data obtaining request includes: index information of a target task corresponding to a task type document block in the document;
a reception module configured to receive a first data obtaining response transmitted by the task server, where the first data obtaining response includes: task content data corresponding to the index information of the target task; and
a display module configured to display, on the basis of the task content data corresponding to the index information of the target task, the task content data at a position of the task type document block in the document.

In a fifth aspect, an example of the disclosure provides an electronic device. The electronic device includes: a processor. The processor is configured to execute a computer program stored in a memory. When the computer program is executed by the processor, steps of any one of the methods according to the first aspect or the second aspect are implemented.

In a sixth aspect, an example of the disclosure provides a computer-readable storage medium, which stores a computer program. When the computer program is executed by a processor, steps of any one of the methods according to the first aspect or the second aspect are implemented.

In a seventh aspect, an example of the disclosure provides a computer program product. When the computer program product runs on a computer, the computer is caused to execute steps of any one of the methods according to the first aspect or the second aspect.

In the technical solution according to the examples of the disclosure, the editing information of the target task transmitted by the client of the first service type is received, where the editing information of the target task includes: the index information of the target task and the editing data for modifying the target task; the client of the second service type containing the target task is determined according to the index information of the target task; the editing information of the target task is transmitted to the client of the second service type to cause the client of the second service type to synchronously modify the target task; and similarly, in response to receiving the editing information of the target task transmitted by the client of the second service type, the editing information of the target task is transmitted to the client of the first service type to cause the client of the first service type to synchronously modify the target task. In this way, the task content data of the client of the first service type can be synchronized to the client of the second service type, and the task content data of the client of the second service type can be synchronized to the client of the first service type to cause the document can be synchronized with the task content data of the task center, so as to facilitate task management of a user.

### BRIEF DESCRIPTION OF THE DRAWINGS

Accompanying drawings herein are incorporated in the description as a constituent part of the description, illustrate examples conforming to the disclosure, and serve to describe principles of the disclosure together with the description.

To more clearly describe technical solutions in the examples of the disclosure or in the prior art, the accompanying drawings required for description of the examples or the prior art will be briefly introduced below. Obviously, those of ordinary skill in the art can also derive other accompanying drawings from these accompanying drawings without making inventive efforts.

FIG. 1A is a schematic diagram of a display picture according to the disclosure;

FIG. 1B is a schematic diagram of another display picture according to the disclosure;

FIG. 1C is a schematic diagram of yet another display picture according to the disclosure;

FIG. 1D is a schematic diagram of yet another display picture according to the disclosure;

FIG. 1E is a schematic diagram of yet another display picture according to the disclosure;

FIG. 2A is a schematic diagram of yet another display picture according to the disclosure;

FIG. 2B is a schematic diagram of yet another display picture according to the disclosure;

FIG. 3 is a schematic flow diagram of a task processing method according to the disclosure;

FIG. 4 is a schematic flow diagram of another task processing method according to the disclosure;

FIG. 5 is a schematic diagram of still another display picture according to the disclosure;

FIG. 6 is a schematic flow diagram of yet another task processing method according to the disclosure;

FIG. 7 is a schematic flow diagram of yet another task processing method according to the disclosure;

FIG. 8 is a schematic flow diagram of yet another task processing method according to the disclosure;

FIG. 9 is a schematic flow diagram of yet another task processing method according to the disclosure;

FIG. 10 is a schematic flow diagram of yet another task processing method according to the disclosure;

FIG. 11 is a schematic flow diagram of still another task processing method according to the disclosure;

FIG. 12 is a schematic structural diagram of an apparatus for processing a task according to the disclosure; and

FIG. 13 is a schematic structural diagram of another apparatus for processing a task according to the disclosure.

### DETAILED DESCRIPTION OF EMBODIMENTS

To make the above objectives, features and advantages of the disclosure more obvious and comprehensible, the solution of the disclosure will be further described below. It should be noted that examples of the disclosure and the features of the examples may be combined with each other without conflict.

Many specific details are set forth in the following description to facilitate full understanding of the disclosure, and the disclosure can also be implemented in other ways different from those described herein. Obviously, the examples in the description are only some examples rather than all examples of the disclosure.

The technical solution of the disclosure may be applied to a terminal device. The terminal device may be a computer, a tablet computer, a mobile phone, or another intelligent electronic device. The terminal device has a display screen. The display screen may be a touch screen or a non-touch screen. For the terminal device having the touch screen, a user may implement an interaction operation with the terminal device by means of a gesture, a finger or, a touch tool (for instance, a stylus). For the terminal device having the non-touch screen, the user may implement an interaction operation with the terminal device by means of an external device (for instance, a mouse or a keyboard).

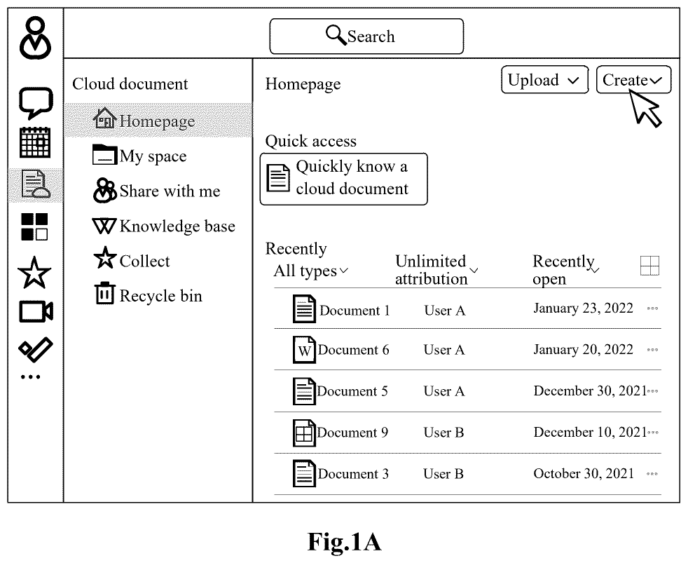

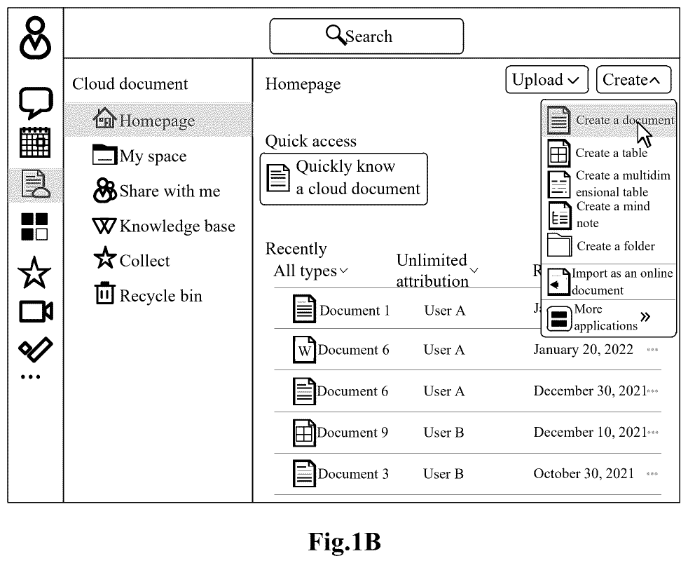

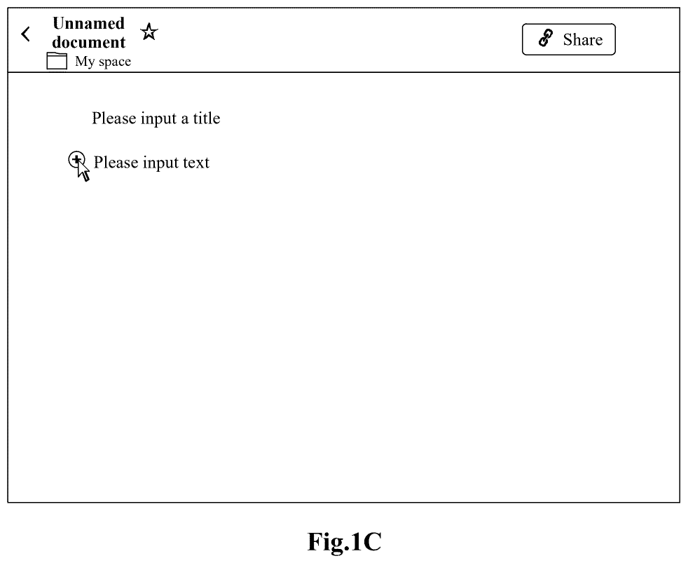

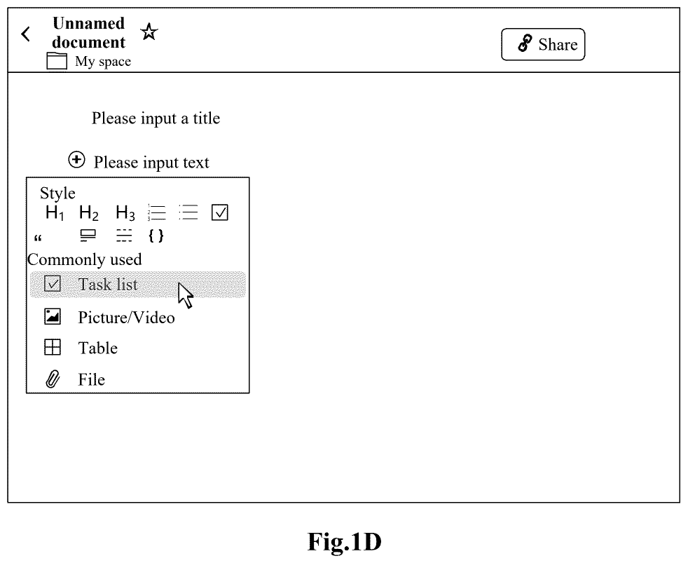

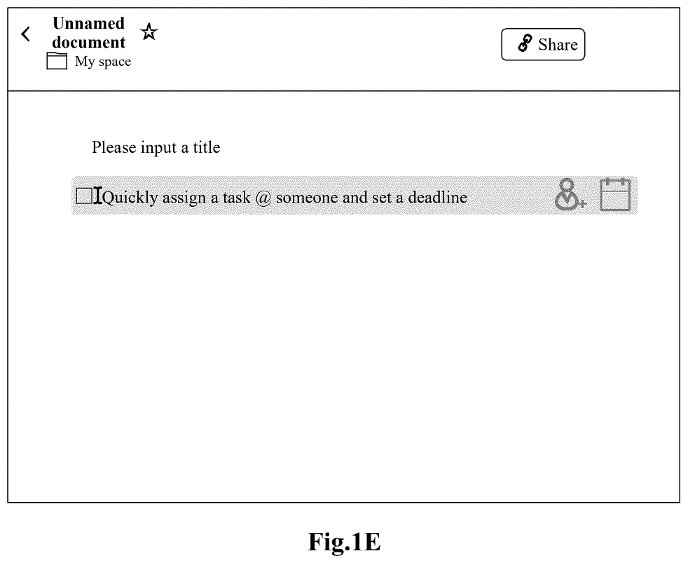

The technical solution in the disclosure may be applied to an instant messaging application as a collaborative work platform. The instant messaging application includes a plurality of application clients, for instance, including an instant messaging application client and an online document application client. An online document may be created in the instant messaging application, as shown in FIGS. 1A and 1B. After a triggering operation of creating a new online document is completed, the instant messaging application jumps from the instant messaging application client to the online document application client. An online document display interface of the online document application client is as shown in FIG. 1C. In the document display interface, specific content of an online document currently opened may be edited. For instance, as shown in FIG. 1C, a user may edit a name of a current online document in a title editing zone and may edit content of the current online document in a text editing zone.

A minimum display unit of the online document shown in FIG. 1C is a document block. That is, each online document consists of a plurality of document blocks, each document block corresponds to one type, and the online document may include a plurality of types of document blocks. For instance, the types of the document blocks may be a text type, a task type, an audio type, a video type, a table type, a file type, etc. On the basis of the operations shown in FIGS. 1C and 1D, the user may select the type of each document block in the online document. For instance, a type of a current document block may be selected as the task type. As shown in FIG. 1D, after selection of the task type is completed, an editing interface of a task type document block may be displayed. As shown in FIG. 1E, task content data such as a task name, a task executor, a task deadline, a task follower, and a task reminder may be added to an editing interface of a task type document block.

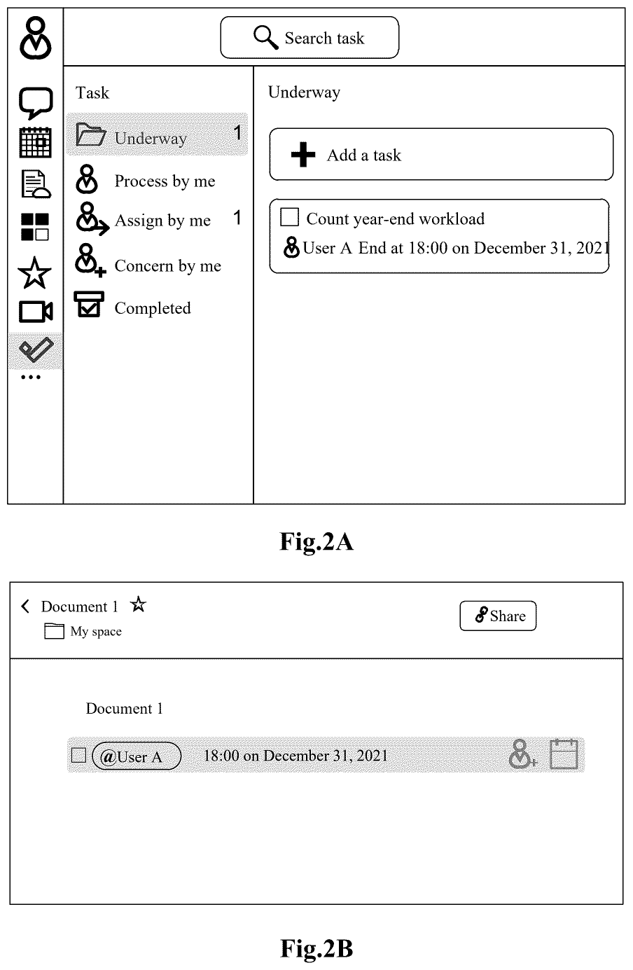

In a document of the online document application client, after editing of the task content data of the task type document block is completed, a corresponding task may be created synchronously in a task panel of the instant messaging application client. For instance, in the online document of the online document application client as shown in FIG. 1E, if a task name is added as “count year-end workload” in the editing interface of the task type document block, a task executor is user A, and a task deadline is added as 18:00 on Dec. 31, 2021, one task is created in the task panel of the instant messaging application client, the task name of the task is “count year-end workload”, the task executor is the user A, and the task deadline is added as 18:00 on Dec. 31, 2021, as shown in FIG. 2.

FIGS. 1, 2 and 6 in the disclosure only illustrate a display interface of the instant messaging application, and do not limit a position of each display frame in the display interface of the instant messaging application and a proportion of each display frame in the entire interface.

In the technical solution according to the disclosure, the editing information of the target task transmitted by the client of the first service type is received, where the editing information of the target task includes: the index information of the target task and the editing data for modifying the target task; the client of the second service type containing the target task is determined according to the index information of the target task; the editing information of the target task is transmitted to the client of the second service type to cause the client of the second service type to synchronously modify the target task; and similarly, in response to receiving the editing information of the target task transmitted by the client of the second service type, the editing information of the target task is transmitted to the client of the first service type to cause the client of the first service type to synchronously modify the target task. In this way, the task content data of the client of the first service type can be synchronized to the client of the second service type, and the task content data of the client of the second service type can be synchronized to the client of the first service type to cause the document can be synchronized with the task content data of the task center, so as to facilitate task management of a user.

The technical solution of the disclosure will be described in detail below in conjunction with several specific examples.

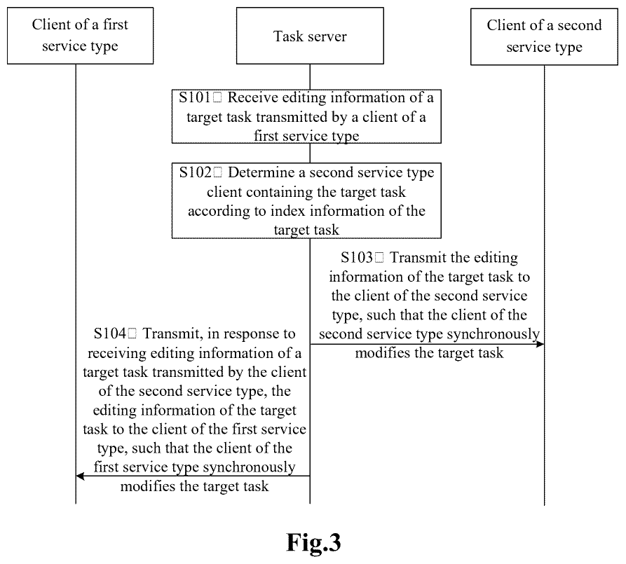

FIG. 3 is a schematic flow diagram of a task processing method according to the disclosure. As shown in FIG. 3, the method includes the following steps:

S101, editing information of a target task transmitted by a client of a first service type is received.

The editing information of the target task includes: index information of the target task and editing data for modifying the target task.

For instance, the client of the first service type may be an online document application client in an instant messaging application. A display interface of the online document application client may be entered by triggering an online document application client control. As shown in FIG. 1A, the display interface of the online document application client may display a plurality of online documents. A user may select one from the plurality of online documents for triggering on the basis of own needs, so as to generate an opening request for the online document. For instance, document 1 may be selected in the display interface of the online document application client as shown in FIG. 1A, and an opening request for document 1 may be generated.

After the online document is opened, as shown in FIG. 2B, the user may modify editing data of a target task in the document 1. The number of the target tasks in the document 1 may be one or more. The editing information of each target task is generated on the basis of index information of each target task in the document 1 and the editing data for modifying each target task, and the online document application client may transmit the generated editing information to a task server. For instance, as shown in FIG. 2B, the editing data for modifying the target task in the document 1 may be as follows: an executor of the target task is user A, and a deadline of the target task is 18:00 on Dec. 31, 2021.

S102, a client of a second service type containing the target task is determined according to the index information of the target task.

For instance, the client of the second service type may be an instant messaging application client. After receiving the editing information of the target task transmitted by the online document application client, the task server may obtain the index information of the target task according to the editing information of the target task, and the task server may determine a reception end of the target task as the instant messaging application client on the basis of the index information of the target task. The instant messaging application client includes the target task.

S103, the editing information of the target task is transmitted to the client of the second service type to cause the client of the second service type to synchronously modify the target task.

The task server transmits the editing information of the target task to the instant messaging application client. After receiving the editing information of the target task, the instant messaging application client modifies task content data of the target task in a task panel, such that the task content data of the modified target task in the task panel is the same as that of the modified target task in the online document.

For instance, if the editing data for modifying the target task in the document 1 of the online document application client of the user may be as follows: an executor of the target task is user A, and a deadline of the target task is 18:00 on Dec. 31, 2021, as shown in FIG. 2B, in the task panel of the instant messaging application client, a task executor of the target task is synchronized to the user A, and a task deadline of the target task is synchronized to 18:00 on Dec. 31, 2021, as shown in FIG. 2A.

S104, in response to receiving the editing information of the target task transmitted by the client of the second service type, the editing information of the target task is transmitted to the client of the first service type to cause the client of the first service type to synchronously modify the target task.

If the instant messaging application client transmits the editing information of the target task to the task server, the task server may transmit the editing information of the target task to the online document application client. After receiving the editing information of the target task, the online document application client modifies the task content data of the target task in the online document, such that the task content data of the modified target task in the online document is the same as that of the modified target task in the task panel.

For instance, if the editing data of modifying the target task in the task panel of the instant messaging application client may be as follows: an executor of the target task is user A, and a task deadline of the target task is 18:00 on Dec. 31, 2021, as shown in FIG. 2A, in the document 1 of the online document application client, a task executor of the target task is synchronized to the user A, and a task deadline of the target task is synchronized to 18:00 on Dec. 31, 2021, as shown in FIG. 2B.

In the example, the editing information of the target task transmitted by the client of the first service type is received, where the editing information of the target task includes: the index information of the target task and the editing data for modifying the target task; the client of the second service type containing the target task is determined according to the index information of the target task; the editing information of the target task is transmitted to the client of the second service type to cause the client of the second service type to synchronously modify the target task; and similarly, in response to receiving the editing information of the target task transmitted by the client of the second service type, the editing information of the target task is transmitted to the client of the first service type to cause the client of the first service type to synchronously modify the target task. In this way, the task content data of the client of the first service type can be synchronized to the client of the second service type, and the task content data of the client of the second service type can be synchronized to the client of the first service type, such that the document can be synchronized with the task content data of the task center, so as to facilitate task management of a user.

In some examples, on the basis of the above example, in the client of the first service type, a document block is regarded as a minimum display unit of an online document, and one online document consists of one or more document blocks. The target task occupies one document block in the online document, and the document block only stores the index information of the target task.

For instance, the client of the first service type is the online document application client, and the document in the online document application client may include one or more document blocks. The document block is regarded as the minimum display unit of the online document. The document block may be at least one of a text type document block, a task type document block, a video type document block, an audio type document block, a table type document block, a file type document block, etc. If the online document includes the task type document block, each task type document block corresponds to one target task, and each target task corresponds to one piece of index information, a task content data obtaining request may be generated on the basis of the index information of the target task corresponding to the task type document block in the online document after the opening request for the online document is generated. In response to the opening request for the online document of the online document application client, the task content data obtaining request is transmitted to the task server. If the online document includes a plurality of task type document blocks, one task content data obtaining request may be generated on the basis of the index information of the target task corresponding to each of the plurality of task type document blocks, that is, the task content data obtaining request includes the index information of a plurality of target tasks, and one task content data obtaining request may also be generated for the index information of the target task corresponding to each task type document block, such that a plurality of task content data obtaining requests may be generated, and the task content data obtaining requests correspond to the index information of the target tasks one by one. If the plurality of task content data obtaining requests are generated, the online document application client may simultaneously or sequentially transmit the plurality of task content data obtaining requests to the task server.

As a collaborative work platform, the instant messaging application includes a plurality of applications, which may be regarded as a collection of a plurality of application clients. For instance, the instant messaging application includes the instant messaging application client and the online document application client. Information interaction occurs between the plurality of applications in the instant messaging application and/or between the instant messaging application and another external system. In order to make information flow between different applications, the instant messaging application may provide a set of block-based framework, which allows one or three applications to create and develop a flexible and interactive application segment on the instant messaging application. The segment is integrated into internal and external environments of the instant messaging application, for instance, the online document application client, the instant messaging application client, a third-party page, etc., which may flow freely. The block-based framework (the block may be the document block in the above example for instance) provided by the instant messaging application is a set of standard framework, and may allow one or three applications to open internal information, convert the internal information into a segment of data having a standard format, and provide one component to display the segment of data. The segment of data having the standard format and a view of the segment of data having the standard format are combined to form a component, that is, a block. The blocks may be embedded and displayed in the application client or a third-party application in the instant messaging application. When the same block is embedded into different applications, the same component is displayed.

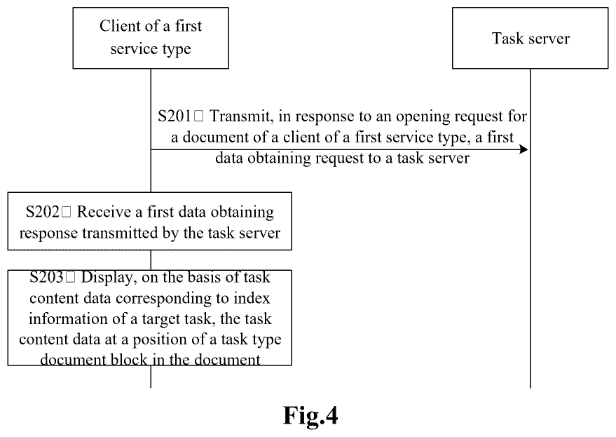

FIG. 4 is a schematic flow diagram of another task processing method according to the disclosure. As shown in FIG. 4, the method includes the following steps:

S201, in response to an opening request for a document of a client of a first service type, a first data obtaining request is transmitted to a task server.

The first data obtaining request includes: index information of a target task corresponding to a task type document block in the document.

For instance, the client of the first service type may be an online document application client in an instant messaging application. A display interface of the online document application client may be entered by triggering an online document application client control. As shown in FIG. 1A, the display interface of the online document application client may display a plurality of online documents. A user may select one from the plurality of online documents for triggering on the basis of own needs, so as to generate an opening request for the online document. For instance, document 1 may be selected in the display interface of the online document application client as shown in FIG. 1A, and an opening request for document 1 may be generated.

The online document may include a plurality of document blocks. The plurality of document blocks may be at least one of a text type document block, a task type document block, a video type document block, an audio type document block, a table type document block, a file type document block, etc. For instance, the online document includes the task type document block, each task type document block corresponds to one task, and each task corresponds to one piece of index information, a task content data obtaining request may be generated on the basis of the index information of the target task corresponding to the task type document block in the online document after the opening request for the online document is generated. In response to the opening request for the online document of the online document application client, the task content data obtaining request is transmitted to the task server. If the online document includes a plurality of task type document blocks, one task content data obtaining request may be generated on the basis of the index information of the target task corresponding to each of the plurality of task type document blocks, that is, the task content data obtaining request includes the index information of a plurality of target tasks, and one task content data obtaining request may also be generated for the index information of the target task corresponding to each task type document block, such that a plurality of task content data obtaining requests may be generated, and the task content data obtaining requests correspond to the index information of the target tasks one by one. If the plurality of task content data obtaining requests are generated, the online document application client may simultaneously or sequentially transmit the plurality of task content data obtaining requests to the task server.

For instance, if the online document includes one task type document block and the task type document block corresponds to index information T1 of target task 1, a task content data obtaining request R1 may be generated on the basis of the index information T1 of the target task 1, and the task content data obtaining request R1 may be transmitted to the task server. If the online document includes two task type document blocks and the two task type document blocks correspond to index information T1 of target task 1 and index information T2 of target task 2 respectively, a task content data obtaining request R1 and a task content data obtaining request R2 may be generated on the basis of the index information T1 of the target task 1 and the index information T2 of the target task 2 respectively, and the task content data obtaining request R1 and the task content data obtaining request R2 may be simultaneously or sequentially transmitted to the task server; or a task content data obtaining request R1′ may be generated on the basis of the index information T1 of the target task 1 and the index information T2 of the target task 2, and the task content data obtaining request R1′ may be transmitted to the task server.

S202, a first data obtaining response transmitted by the task server is received.

The first data obtaining response includes: task content data corresponding to the index information of the target task.

The task server receives the task content data obtaining request transmitted by the online document application client, and analyzes the task content data obtaining request, such that the index information of the corresponding target task may be obtained. On the basis of the index information of the target task, the task content data stored in the task server is searched for, and task content data corresponding to index information of any target task is obtained. The task content data obtaining response is generated on the basis of the task content data obtained. If the online document includes one task type document block, the task content data obtaining response includes the task content data corresponding to the index information of the target task. If the document includes a plurality of task type document blocks, the task content data obtaining response includes the index information of a plurality of target tasks and the corresponding task content data. The task server may return the task content data obtaining response to the online document application client.

For instance, on the basis of the above example, if the online document includes one task type document block, the task server receives the task content data obtaining request R1, and analyzes the task content data obtaining request R1, such that the index information T1 of the target task 1 may be obtained. Task content data M1 corresponding to the index information T1 of the target task 1 may be obtained on the basis of the task content data stored by the task server itself, a task content data obtaining response A1 may be generated on the basis of the task content data M1, and the task content data obtaining response A1 may be returned to the online document application client. If the online document includes two task type document blocks, the task server may analyze a task content data obtaining request received, and obtain index information T1 of target task 1 and index information T2 of target task 2. Task content data M1 corresponding to the index information T1 of the target task 1 and task content data M2 corresponding to the index information T2 of the target task 2 may be determined on the basis of the task content data stored by the task server itself, such that a task content data obtaining response A1 and a task content data obtaining response A2 may be generated on the basis of the index information T1 of the target task 1 and the corresponding task content data M1, and the index information T2 of the target task 2 and the corresponding task content data M2, respectively, and the task content data obtaining response A1 and the task content data obtaining response A2 may be simultaneously or sequentially returned to the online document application client; or a task content data obtaining response A1′ may be generated on the basis of the index information T1 of the target task 1 and the corresponding task content data M1, and the index information T2 of the target task 2 and the corresponding task content data M2, and the task content data obtaining response A1′ may be returned to the online document application client.

S203, on the basis of the task content data corresponding to the index information of the target task, the task content data is displayed at a position of the task type document block in the document.

If the online document includes one task type document block, the online document application client analyzes a task content data obtaining response received, such that the task content data corresponding to the index information of the target task may be obtained, and the task content data may be displayed in the task type document block in the online document. If the online document includes a plurality of task type document blocks, the online document application client analyzes a task content data obtaining response received, such that the index information of a plurality of target tasks and the corresponding task content data may be obtained, and each task content data may be displayed in the corresponding task type document block in the online document.

For instance, on the basis of the above example, if the online document includes one task type document block, the online document application client analyzes a task content data obtaining response A1, such that task content data M1 is obtained, and the task content data M1 is displayed in the task type document block in the online document. If the online document includes two task type document blocks, the online document application client may analyze a task content data obtaining response A1 and a task content data obtaining response A2, or a task content data obtaining response A1′, such that index information T1 of target task 1 and corresponding task content data M1, and index information T2 of target task 2 and corresponding task content data M2 are obtained, the task content data M1 is displayed in a task type document block corresponding to the index information T1 of the target task 1 in the online document, and the task content data M2 is displayed in a task type document block corresponding to the index information T2 of the target task 2 in the online document.

In the example, in response to the opening request for the document of the client of the first service type, the first data obtaining request is transmitted to the task server. The first data obtaining request includes: the index information of the target task corresponding to the task type document block in the document. The first data obtaining response transmitted by the task server is received. The first data obtaining response includes: the task content data corresponding to the index information of the target task. On the basis of the task content data corresponding to the index information of the target task, the task content data is displayed at the position of the task type document block in the document. In this way, the task content data in the document is stored in the task server, and the task content data may be obtained without verifying user authority on the document, such that the task content data in the document may be synchronized.

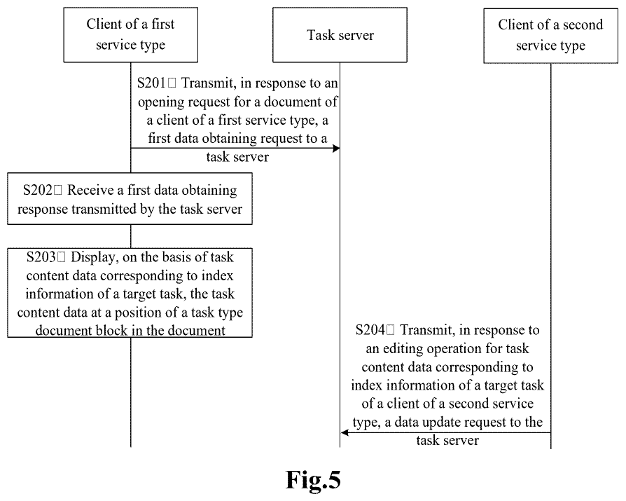

FIG. 5 is a schematic flow diagram of yet another task processing method according to the disclosure. In FIG. 5 based on the example shown in FIG. 4, the method further includes the following steps:

S204, in response to an editing operation for task content data corresponding to index information of a target task of a client of a second service type, a data update request is transmitted to a task server.

The data update request includes: update content corresponding to the editing operation, to cause the task server to update the task content data corresponding to the index information of the target task.

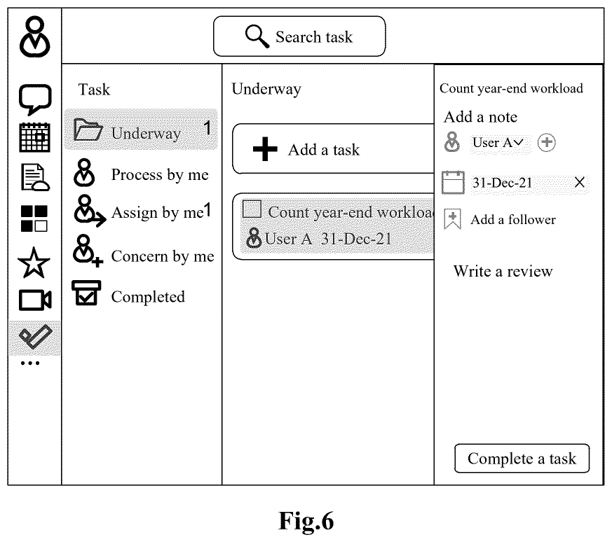

For instance, the client of the second service type may be an instant messaging application client. A display interface of a task panel may be entered by triggering a task panel control of the instant messaging application client. As shown in FIG. 2A, the task panel includes at least one task. A user may select one task from at least one task for triggering on the basis of own needs, so as to enter an editing interface of the task. For instance, as shown in FIG. 2A, the task panel includes one task, and an editing interface of the task is entered by triggering the task, as shown in FIG. 6. The user may edit the task content data in the editing interface of the task, and for instance, may edit a task name, a task executor, a task follower, a task deadline, etc. of the task.

The task content data in the task panel corresponds to index information of a target task of a task type document block in an online document. After the user completes editing of the task content data in the task panel, the instant messaging application client may generate the data update request on the basis of the task content data edited and the corresponding index information of the target task. In response to the editing operation for the task content data in the task panel, the instant messaging application client transmits the data update request to the task server. After receiving the data update request, the task server analyzes the data update request, such that the updated task content data in the task panel and the index information of the corresponding target task may be obtained, and original task content data, corresponding to the index information of the target task, stored in the task server is replaced with the updated task content data.

For instance, the user edits a task deadline of task content data M1 in the task panel, and the task content data M1 corresponds to index information T1 of target task 1. An original task deadline before editing is Dec. 31, 2021, and an updated task deadline is Jan. 5, 2022. If the updated task content data is recorded as task content data M1′, the task content data M1′ may correspond to the index information T1 of the target task 1. The instant messaging application client generates a data update request G1 on the basis of the task content data M1′ and the corresponding index information T1 of the target task 1. The task server receives and analyzes the data update request G1, such that the task content data M1′ and the corresponding index information T1 of the target task 1 are obtained, the task content data M1, corresponding to the index information T1 of the target task 1, stored by the task server itself is found, and the task content data M1 is updated to the task content data M1′.

In the example, in response to the editing operation for the task content data corresponding to the index information of the target task of the client of the second service type, the data update request is transmitted to the task server. The data update request includes: the update content corresponding to the editing operation, to cause the task server to update the task content data corresponding to the index information of the target task. In this way, the task content data stored in the task server may be updated by editing the task content data in the task panel, such that task content data displayed in the online document may be synchronized with the task content data in the task panel.

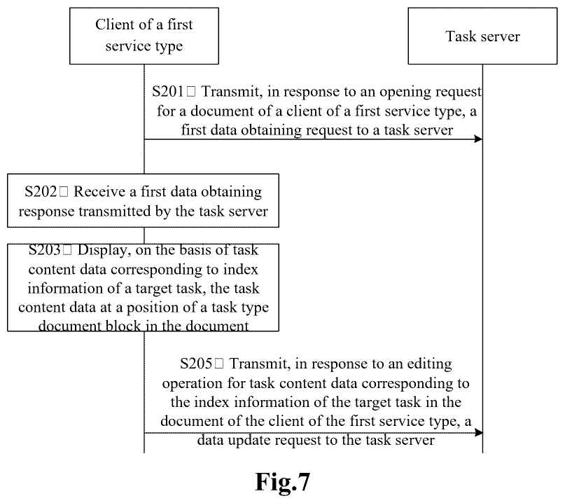

FIG. 7 is a schematic flow diagram of yet another task processing method according to the disclosure. In FIG. 7 based on the example shown in FIG. 4, the method further includes the following steps:

S205, in response to an editing operation for task content data corresponding to index information of a target task in a document of a client of a first service type, a data update request is transmitted to a task server.

The data update request includes: update content corresponding to the editing operation, to cause the task server to update the task content data corresponding to the index information of the target task.

A display interface of an online document application client may be entered by means of an online document application client control in an instant messaging application. As shown in FIG. 1A, the display interface of the online document application client may display at least one online document. A user may select one online document for triggering on the basis of own needs, so as to enter a display interface of the online document. For instance, as shown in FIG. 1A, the display interface of the online document application client displays a plurality of online documents. An online document having a name of document 1 may be selected to be triggered, such that a display interface of the document 1 may be entered, as shown in FIG. 2B. The user may edit task content data in a task type document block in the editing interface of the document 1, and for instance, may edit a task name, a task executor, a task follower, a task deadline, etc.

Each task type document block in the online document corresponds to index information of one target task. After the user completes editing of the task content data in the task type document block in the document, the online document application client may generate the data update request on the basis of the task content data edited and the corresponding index information of the target task. In response to the editing operation for the task content data in the task type document block, the online document application client transmits the data update request to the task server. After receiving the data update request, the task server analyzes the data update request, such that the updated task content data in the task type document block and the index information of the corresponding target task may be obtained, and original task content data, corresponding to the index information of the target task, stored in the task server is replaced with the updated task content data.

For instance, the user edits a task deadline of task content data M1 of task type document block 1 in the task type document block in the document, and the task content data M1 corresponds to index information T1 of target task 1. An original task deadline before editing is Dec. 31, 2021, and an updated task deadline is Jan. 5, 2022. If the updated task content data is recorded as task content data M1′, the task content data M1′ may correspond to the index information T1 of the target task 1. The online document application client generates a data update request G1 on the basis of the task content data M1′ and the corresponding index information T1 of the target task 1. The task server receives and analyzes the data update request G1, such that the task content data M1′ and the corresponding index information T1 of the target task 1 are obtained, the task content data M1, corresponding to the index information T1 of the target task 1, stored by the task server itself is found, and the task content data M1 is updated to the task content data M1′.

In the example, in response to the editing operation for the task content data corresponding to the index information of the target task in the document of the client of the first service type, the data update request is transmitted to the task server. The data update request includes: the update content corresponding to the editing operation, to cause the task server to update the task content data corresponding to the index information of the target task. In this way, the task content data stored in the task server may be updated by means of the task type document block of the document in the online document application client, such that task content data in the task panel may be synchronized with the task content data displayed in the document.

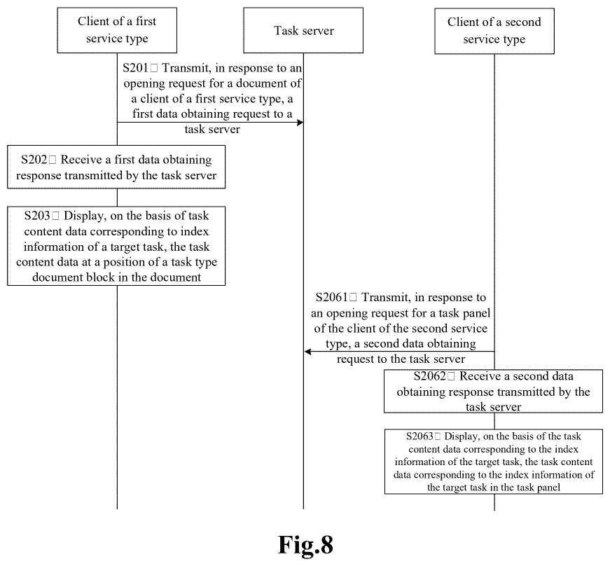

FIG. 8 is a schematic flow diagram of yet another task processing method according to the disclosure. In FIG. 8 based on the example shown in FIG. 4, the method further includes the following steps:

S2061, in response to an opening request for a task panel of a client of a second service type, a second data obtaining request is transmitted to a task server.

The second data obtaining request includes: index information of a target task included in the task panel.

The task panel includes one target task or a plurality of target tasks. Each target task corresponds to one piece of index information. In this way, the task panel may include index information of one or more target tasks. A task content data obtaining request may be generated on the basis of the index information of one or more target tasks included in the task panel, and in response to the opening request for the task panel, an instant messaging application client may transmit the task content data obtaining request to the task server. For instance, the task panel includes a plurality of target tasks, one task content data obtaining request may be generated on the basis of the index information of each of the plurality of target tasks, that is, the task content data obtaining request includes the index information of the plurality of target tasks, and one task content data obtaining request may also be generated for the index information of each target task, such that a plurality of task content data obtaining requests may be generated, and the task content data obtaining requests correspond to the index information of the target tasks one by one. If the plurality of task content data obtaining requests are generated, the instant messaging application client may simultaneously or sequentially transmit the plurality of task content data obtaining requests to the task server.

For instance, if the task panel includes one target task 1 and index information of the target task 1 is denoted by T1, the instant messaging application client may generate a task content data obtaining request R3 on the basis of the index information T1 of the target task 1, and may transmit the task content data obtaining request R3 to the task server. If the task panel includes two target tasks and index information of the two target tasks is index information T1 of target task 1 and index information T2 of target task 2 respectively, the instant messaging application client may generate a task content data obtaining request R3 and a task content data obtaining request R4 on the basis of the index information T1 of the target task 1 and the index information T2 of the target task 2 respectively, and simultaneously or sequentially transmit the task content data obtaining request R3 and the task content data obtaining request R4 to the task server; or may generate a task content data obtaining request R3′ may be generated on the basis of the index information T1 of the target task 1 and the index information T2 of the target task 2, and transmit the task content data obtaining request R3′ to the task server.

S2062, a second data obtaining response transmitted by the task server is received.

The second data obtaining response includes: the task content data corresponding to the index information of the target task.

The task server receives the task content data obtaining request transmitted by the instant messaging application client, and analyzes the task content data obtaining request, such that the index information of the corresponding target task may be obtained. On the basis of the index information of the target task, the task content data stored in the task server is searched for, and the task content data corresponding to the index information of the target task is obtained. The task content data obtaining response is generated on the basis of the task content data obtained. If the task panel includes one target task, the task content data obtaining response includes the task content data corresponding to the index information of the target task. If the task panel includes a plurality of target tasks, the task content data obtaining response includes task content data corresponding to index information of the plurality of target tasks. The task server may return the task content data obtaining response to the instant messaging application client.

For instance, on the basis of the above example, if the task panel includes one target task, the task server receives the task content data obtaining request R3, and analyzes the task content data obtaining request R3, such that the index information T1 of the target task 1 may be obtained. Task content data M1 corresponding to the index information T1 of the target task 1 may be obtained on the basis of the task content data stored by the task server itself, a task content data obtaining response A3 may be generated on the basis of the task content data M1, and the task content data obtaining response A3 may be returned to the instant messaging application client. If the task panel includes a plurality of target tasks, the task server may analyze a task content data obtaining request received, and obtain index information T1 of target task 1 and index information T2 of target task 2. Task content data M1 corresponding to the index information T1 of the target task 1 and task content data M2 corresponding to the index information T2 of the target task 2 may be determined on the basis of the task content data stored by the task server itself, such that a task content data obtaining response A3 and a task content data obtaining response A4 may be generated on the basis of the index information T1 of the target task 1 and the corresponding task content data M1, and the index information T2 of the target task 2 and the corresponding task content data M2, respectively, and the task content data obtaining response A3 and the task content data obtaining response A4 may be simultaneously or sequentially returned to the instant messaging application client; or a task content data obtaining response A3′ may be generated on the basis of the index information T1 of the target task 1 and the corresponding task content data M1, and the index information T2 of the target task 2 and the corresponding task content data M2, and the task content data obtaining response A3′ may be returned to the instant messaging application client.

S2063, on the basis of the task content data corresponding to the index information of the target task, the task content data corresponding to the index information of the target task is displayed in the task panel

If the task panel includes one target task, the instant messaging application client analyzes a task content data obtaining response received, such that the task content data corresponding to the index information of the target task may be obtained, and the task content data may be displayed in the task panel. If the task panel includes a plurality of target tasks, the instant messaging application client analyzes a task content data obtaining response received, such that index information of the plurality of target tasks and the corresponding task content data may be obtained, and each task content data may be displayed in a corresponding zone in the task panel.

For instance, on the basis of the above example, if the task panel includes one target task, the instant messaging application client analyzes a task content data obtaining response A3, such that task content data M1 is obtained, and the task content data M1 is displayed in the task panel. If the task panel includes two target tasks, the instant messaging application client may analyze a task content data obtaining response A3 and a task content data obtaining response A4, or a task content data obtaining response A3′, such that index information T1 of target task 1 and corresponding task content data M1, and index information T2 of target task 2 and corresponding task content data M2 are obtained, the task content data M1 is displayed in a zone corresponding to the index information T1 of the target task 1 in the task panel, and the task content data M2 is displayed in a zone corresponding to the index information T2 of the target task 2 in the task panel.

In the example, in response to the opening request for the task panel of the client of the second service type, the second data obtaining request is transmitted to the task server. The second data obtaining request includes: the index information of the target task included in the task panel. The second data obtaining response transmitted by the task server is received. The second data obtaining response includes: the task content data corresponding to the index information of the target task. On the basis of the task content data corresponding to the index information of the target task, the task content data corresponding to the index information of the target task is displayed in the task panel. In this way, the task content data in the task panel is stored in the task server, such that task content data in the document may be synchronized with the task content data in the task panel.

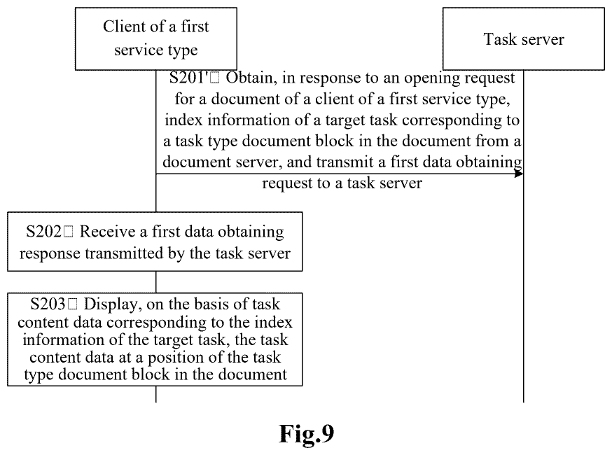

FIG. 9 is a schematic flow diagram of yet another task processing method according to the disclosure. In FIG. 9 based on the example shown in FIG. 4, one possible implementation of executing S201 is specifically described as follows:

S201′, in response to an opening request for a document of a client of a first service type, index information of a target task corresponding to a task type document block in the document is obtained from a document server, and a first data obtaining request is transmitted to a task server.

Index information of a target task corresponding to each task type document block in an online document is stored in an online document server. In response to an opening request for an online document of an online document application client, the index information of the target tasks corresponding to all the task type document blocks in the online document may be obtained from the online document server. The online document application client may further generate a task content data obtaining request on the basis of the index information of each target task, and transmit the task content data obtaining request to the task server, so as to obtain the task content data displayed in each task type document block in the online document.

For instance, an execution document includes one task type document block, in response to the opening request for the online document, index information T1 of target task 1 may be obtained from the online document server, and a task content data obtaining request R1 may be generated on the basis of the index information T1 of the target task 1. For instance, the online document includes a plurality of task type document blocks, in response to the opening request for the online document, index information T1 of target task 1 and index information T2 of target task 2 may be obtained from the online document server, and a task content data obtaining request R1 and a task content data obtaining request R2 may be generated on the basis of the index information T1 of the target task 1 and the index information T2 of the target task 2 respectively, or a task content data obtaining request R1′ may be generated.

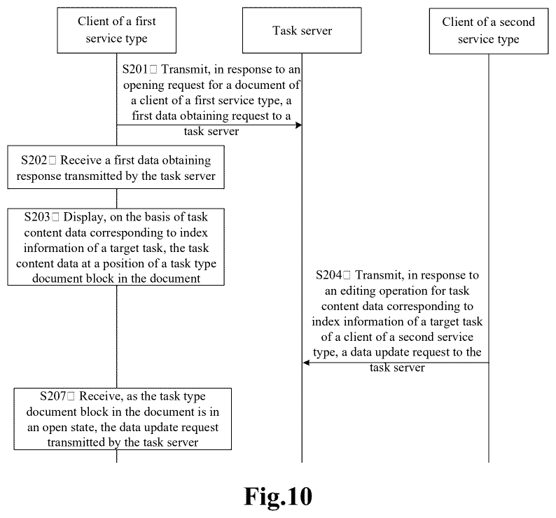

FIG. 10 is a schematic flow diagram of yet another task processing method according to the disclosure. In FIG. 10 based on the example shown in FIG. 5, the method further includes the following steps:

S207, as a task type document block in a document is in an open state, a data update request transmitted by a task server is received.

The data update request includes: update data. The data update request is for requesting, at the document, updating and rendering the task type document block on the basis of the update data received.

For instance, an online document application client in an instant messaging application is in an open state, and the online document application client displays one online document that is in an open state. The online document includes at least one task type document block. Each task type document block corresponds to index information of one target task. If a user currently updates one piece of task content data in a task panel of an instant messaging application client, and index information of a target task corresponding to the updated task content data corresponds to any one of all the task type document blocks in an online document currently opened, the corresponding task content data stored in the task server is updated. After updating of the task content data in the task server is completed, a data update request is generated on the basis of the updated task content data and the corresponding index information of the target task, and the data update request is transmitted to the online document application client.

The online document application client receives the data update request transmitted by the task server, the updated task content data and the corresponding index information of the target task is obtained by analyzing the data update request, and the updated task content data is displayed in the corresponding task type document block in the online document currently opened according to the index information of the target task, such that real-time updating and synchronization of the task content data in the online document are completed.

For instance, the user updates the task content data in the task panel of the instant messaging application client. The updated task content data is denoted by M1′, and the task content data before updating is denoted by M1. The task content data M1/task content data M1′ corresponds to index information T1 of target task 1. The task server may generate a data update request G1′ on the basis of the received index information T1 of the target task 1 transmitted by the instant messaging application client and the corresponding task content data M1′. If the online document opened includes one task type document block corresponding to a task identifier T1, the online document application client analyzes the data update request G1′ received, such that the index information T1 of the target task 1 and the corresponding task content data M1′ may be obtained, and the task content data M1′ may be displayed in the task type document block corresponding to the index information T1 of the target task 1 in the online document currently opened.

In the example, as the task type document block in the document is in an open state, the data update request transmitted by the task server is received. The data update request includes: update data. The data update request is for requesting, at the document, updating and rendering the task type document block on the basis of the update data received. In this way, as the document is in an open state, on the basis of updating of the task content data in a current task panel, the updated task content data may be updated and displayed in the task type document block in real time without additional operation, such that real-time automatic synchronization of the task content data in the document may be implemented.

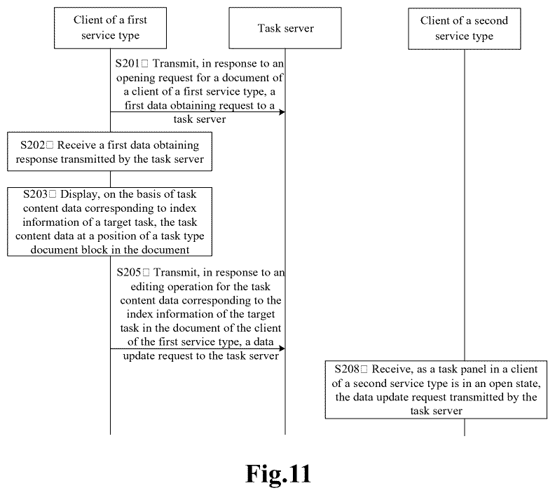

FIG. 11 is a schematic flow diagram of still another task processing method according to the disclosure. In FIG. 11 based on the example shown in FIG. 7, the method further includes the following steps:

S208, as a task panel in a client of a second service type is in an open state, a data update request transmitted by a task server is received.

The data update request includes: update data. The data update request is for requesting, at the task panel, updating and rendering a task type document block on the basis of the update data received.

For instance, a task panel of an instant messaging application client is in an open state, and the task panel displays at least one target task. Each target task corresponds to one piece of index information. If a user currently updates task content data in one task type document block in an online document, and index information of a target task corresponding to the updated task content data corresponds to any one of all the target tasks displayed in the task panel, the corresponding task content data stored in the task server is updated. After updating of the task content data in the task server is completed, a data update request is generated on the basis of the updated task content data and the corresponding index information of the target task, and the data update request is transmitted to the instant messaging application client.

The instant messaging application client receives the data update request transmitted by the task server, the updated task content data and the corresponding index information of the target task is obtained by analyzing the data update request, and the updated task content data is displayed in a zone, corresponding to the index information of the target task, in the task panel according to the index information of the target task, such that real-time updating and synchronization of the task content data in the task panel are completed.

For instance, the user updates the task content data in one task type document block in the online document. The updated task content data is denoted by M1′, and the task content data before updating is denoted by M1. The task content data M1/task content data M1′ corresponds to index information T1 of target task 1. The task server may generate a data update request G1′ on the basis of the received index information T1 of the target task 1 transmitted by the instant messaging application client and the corresponding task content data M1′. If the task panel includes the index information T1 of the target task 1, the instant messaging application client analyzes the data update request G1′ received, such that the task content data M1′ corresponding to the index information T1 of the target task 1 may be obtained, and the task content data M1′ may be displayed in a zone, corresponding to the index information T1 of the target task 1, in the task panel.

In the example, as the task panel in the client of the second service type is in an open state, the data update request transmitted by the task server is received. The data update request includes: the update data. The data update request is for requesting, at the task panel, updating and rendering the task type document block on the basis of the update data received.

In this way, as the task panel is in an open state, the updated task content data may be updated and displayed in real time on the basis of updating of task content data in a current document without additional operation, such that real-time automatic synchronization of the task content data in the task panel may be implemented.

In some examples, on the basis of the above example, in the client of the first service type, a document block is regarded as a minimum display unit of an online document, and one online document consists of one or more document blocks. The target task occupies one task type document block in the online document, and the task type document block only stores the index information of the target task.

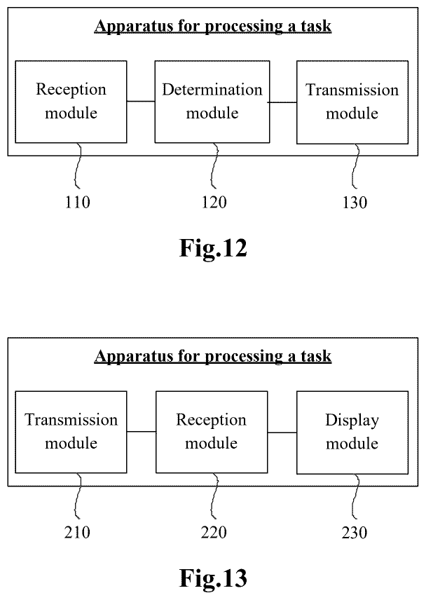

An example of the disclosure further provides an apparatus for processing a task. FIG. 12 is a schematic structural diagram of an apparatus for processing a task according to the disclosure. As shown in FIG. 12, the apparatus for processing a task includes:
a reception module 110 configured to receive editing information of a target task transmitted by a client of a first service type, where the editing information of the target task includes: index information of the target task and editing data for modifying the target task;
a determination module 120 configured to determine a client of a second service type containing the target task according to the index information of the target task; and
a transmission module 130 configured to transmit the editing information of the target task to the client of the second service type, such that the client of the second service type to synchronously modify the target task; and configured to transmit, in response to receiving editing information of a target task transmitted by the client of the second service type, the editing information of the target task to the client of the first service type, such that the client of the first service type to synchronously modify the target task.

In some examples, the client of the first service type is an online document application client, and the client of the second service type is an instant messaging application client.

In some examples, in the client of the first service type, a document block is regarded as a minimum display unit of an online document, and one online document consists of one or more document blocks. The target task occupies one document block in the online document, and the document block only stores the index information of the target task.

An example of the disclosure further provides an apparatus for processing a task. FIG. 13 is a schematic structural diagram of another apparatus for processing a task according to the disclosure. As shown in FIG. 13, the apparatus for processing a task includes:
a transmission module 210 configured to transmit, in response to an opening request for a document of a client of a first service type, a first data obtaining request to a task server, where the first data obtaining request includes: index information of a target task corresponding to a task type document block in the document;
a reception module 220 configured to receive a first data obtaining response transmitted by the task server, where the first data obtaining response includes: task content data corresponding to the index information of the target task; and
a display module 230 configured to display, on the basis of the task content data corresponding to the index information of the target task, the task content data at a position of the task type document block in the document.

In some examples, the transmission module 210 is further configured to transmit, in response to an editing operation for task content data corresponding to index information of a target task of a client of a second service type, a data update request to the task server, where the data update request includes: update content corresponding to the editing operation, to cause the task server to update the task content data corresponding to the index information of the target task.

In some examples, the transmission module 210 is further configured to transmit, in response to an editing operation for task content data corresponding to the index information of the target task in the document of the client of the first service type, a data update request to the task server, where the data update request includes: update content corresponding to the editing operation, to cause the task server to update the task content data corresponding to the index information of the target task.

In some examples, the transmission module 210 is further configured to transmit, in response to an opening request for a task panel of the client of the second service type, a second data obtaining request to the task server. The second data obtaining request includes: index information of a target task included in the task panel.

The reception module 220 is further configured to receive a second data obtaining response transmitted by the task server. The second data obtaining response includes: the task content data corresponding to the index information of the target task.

The display module 230 is further configured to display, on the basis of the task content data corresponding to the index information of the target task, the task content data corresponding to the index information of the target task in the task panel.

In some examples, the transmission module 210 is further configured to obtain, in response to the opening request for the document of the client of the first service type, the index information of the target task corresponding to the task type document block in the document from a document server, and transmit the first data obtaining request to the task server.

In some examples, the reception module 220 is further configured to receive, as the task type document block in the document is in an open state, the data update request transmitted by the task server. The data update request includes: update data. The data update request is for requesting, at the document, updating and rendering the task type document block on the basis of the update data received.

In some examples, the reception module 220 is further configured to receive, as a task panel in a client of a second service type is in an open state, the data update request transmitted by the task server. The data update request includes: update data. The data update request is for requesting, at the task panel, updating and rendering the task type document block on the basis of the update data received.

In some examples, in the client of the first service type, a document block is regarded as a minimum display unit of an online document, and one online document consists of one or more document blocks. The target task occupies one task type document block in the online document, and the task type document block only stores the index information of the target task.

The apparatus according to the example of the disclosure may execute the method according to any one of the examples of the disclosure, and has corresponding functional modules and beneficial effects corresponding to execution of the method.

The disclosure provides an electronic device. The electronic device includes: a processor. The processor is configured to execute a computer program stored in a memory. When the processor executes the computer program, steps of any one of the method examples are implemented.

The disclosure provides a computer-readable storage medium, which stores a computer program. When the computer program is executed by a processor, steps of any one of the method examples are implemented.

The disclosure provides a computer program product. When the computer program product runs on a computer, the computer is caused to execute steps of any one of the method examples.

In a first aspect, the disclosure provides a task processing method. The method includes the following steps:
editing information of a target task transmitted by a client of a first service type is received, where the editing information of the target task includes: index information of the target task and editing data for modifying the target task;
a client of a second service type containing the target task is determined according to the index information of the target task;
the editing information of the target task is transmitted to the client of the second service type, such that the client of the second service type to synchronously modify the target task; and
similarly, in response to receiving editing information of a target task transmitted by the client of the second service type, the editing information of the target task is transmitted to the client of the first service type, such that the client of the first service type to synchronously modify the target task.

In some examples, the client of the first service type is an online document application client, and the client of the second service type is an instant messaging application client.

In some examples, in the client of the first service type, a document block is regarded as a minimum display unit of an online document, and one online document consists of one or more document blocks. The target task occupies one document block in the online document, and the document block only stores the index information of the target task.

In a second aspect, the disclosure provides a task processing method. The method includes the following steps:
in response to an opening request for a document of a client of a first service type, a first data obtaining request is transmitted to a task server, where the first data obtaining request includes: index information of a target task corresponding to a task type document block in the document;
a first data obtaining response transmitted by the task server is received, where the first data obtaining response includes: task content data corresponding to the index information of the target task; and
on the basis of the task content data corresponding to the index information of the target task, the task content data is displayed at a position of the task type document block in the document.

In some examples, the method further includes the following steps: in response to an editing operation for task content data corresponding to index information of a target task of a client of a second service type, a data update request is transmitted to the task server, where the data update request includes: update content corresponding to the editing operation, to cause the task server to update the task content data corresponding to the index information of the target task.

In some examples, the method further includes the following steps: in response to an editing operation for task content data corresponding to the index information of the target task in the document of the client of the first service type, a data update request is transmitted to the task server, where the data update request includes: update content corresponding to the editing operation, to cause the task server to update the task content data corresponding to the index information of the target task.

In some examples, the method further includes the following steps: in response to an opening request for a task panel of the client of the second service type, a second data obtaining request is transmitted to the task server, where the second data obtaining request includes: index information of a target task included in the task panel;
a second data obtaining response transmitted by the task server is received, where the second data obtaining response includes: the task content data corresponding to the index information of the target task; and
on the basis of the task content data corresponding to the index information of the target task, the task content data corresponding to the index information of the target task is displayed in the task panel.

In some examples, the step that in response to the opening request for the document of the client of the first service type, the first data obtaining request is transmitted to the task server includes the following step:
in response to the opening request for the document of the client of the first service type, the index information of the target task corresponding to the task type document block in the document is obtained from a document server, and the first data obtaining request is transmitted to the task server.

In some examples, the method further includes the following step: as the task type document block in the document is in an open state, the data update request transmitted by the task server is received. The data update request includes: update data. The data update request is for requesting, at the document, updating and rendering the task type document block on the basis of the update data received.

In some examples, the method further includes the following step: as a task panel in a client of a second service type is in an open state, the data update request transmitted by the task server is received. The data update request includes: update data. The data update request is for requesting, at the task panel, updating and rendering the task type document block on the basis of the update data received.

In some examples, in the client of the first service type, a document block is regarded as a minimum display unit of an online document, and one online document consists of one or more document blocks. The target task occupies one task type document block in the online document, and the task type document block only stores the index information of the target task.

In a third aspect, the disclosure provides an apparatus for processing a task. The apparatus includes:
a reception module configured to receive editing information of a target task transmitted by a client of a first service type, where the editing information of the target task includes: index information of the target task and editing data for modifying the target task;
a determination module configured to determine a client of a second service type containing the target task according to the index information of the target task; and
a transmission module configured to transmit the editing information of the target task to the client of the second service type, such that the client of the second service type to synchronously modify the target task; and configured to transmit, in response to receiving editing information of a target task transmitted by the client of the second service type, the editing information of the target task to the client of the first service type, such that the client of the first service type to synchronously modify the target task.

In some examples, the client of the first service type is an online document application client, and the client of the second service type is an instant messaging application client.

In some examples, in the client of the first service type, a document block is regarded as a minimum display unit of an online document, and one online document consists of one or more document blocks. The target task occupies one document block in the online document, and the document block only stores the index information of the target task.

In a fourth aspect, the disclosure provides an apparatus for processing a task. The apparatus includes:
a transmission module configured to transmit, in response to an opening request for a document of a client of a first service type, a first data obtaining request to a task server, where the first data obtaining request includes: index information of a target task corresponding to a task type document block in the document;
a reception module configured to receive a first data obtaining response transmitted by the task server, where the first data obtaining response includes: task content data corresponding to the index information of the target task; and
a display module configured to display, on the basis of the task content data corresponding to the index information of the target task, the task content data at a position of the task type document block in the document.

In some examples, the transmission module is further configured to transmit, in response to an editing operation for task content data corresponding to index information of a target task of a client of a second service type, a data update request to the task server, where the data update request includes: update content corresponding to the editing operation, to cause the task server to update the task content data corresponding to the index information of the target task.

In some examples, the transmission module is further configured to transmit, in response to an editing operation for task content data corresponding to the index information of the target task in the document of the client of the first service type, a data update request to the task server, where the data update request includes: update content corresponding to the editing operation, to cause the task server to update the task content data corresponding to the index information of the target task.

In some examples, the transmission module is further configured to transmit, in response to an opening request for a task panel of the client of the second service type, a second data obtaining request to the task server. The second data obtaining request includes: index information of a target task included in the task panel.

The reception module is further configured to receive a second data obtaining response transmitted by the task server. The second data obtaining response includes: the task content data corresponding to the index information of the target task.

The display module is further configured to display, on the basis of the task content data corresponding to the index information of the target task, the task content data corresponding to the index information of the target task in the task panel.

In some examples, the transmission module is further configured to obtain, in response to the opening request for the document of the client of the first service type, the index information of the target task corresponding to the task type document block in the document from a document server, and transmit the first data obtaining request to the task server.

In some examples, the reception module is further configured to receive, as the task type document block in the document is in an open state, the data update request transmitted by the task server. The data update request includes: update data. The data update request is for requesting, at the document, updating and rendering the task type document block on the basis of the update data received.

In some examples, the reception module is further configured to receive, as a task panel in a client of a second service type is in an open state, the data update request transmitted by the task server. The data update request includes: update data. The data update request is for requesting, at the task panel, updating and rendering the task type document block on the basis of the update data received.

In some examples, in the client of the first service type, a document block is regarded as a minimum display unit of an online document, and one online document consists of one or more document blocks. The target task occupies one task type document block in the online document, and the task type document block only stores the index information of the target task.

In a fifth aspect, the disclosure provides an electronic device. The electronic device includes: a processor. The processor is configured to execute a computer program stored in a memory. When the computer program is executed by the processor, steps of any one of the methods according to the first aspect or the second aspect are implemented.

In a sixth aspect, an example of the disclosure provides a computer-readable storage medium, which stores a computer program. When the computer program is executed by a processor, steps of any one of the methods according to the first aspect or the second aspect are implemented.

In a seventh aspect, an example of the disclosure provides a computer program product. When the computer program product runs on a computer, the computer is caused to execute steps of any one of the methods according to the first aspect or the second aspect.

It should be noted that relational terms herein such as “first” and “second” are only used to distinguish one entity or operation from another entity or operation without necessarily requiring or implying any actual such relation or order between such entities or operations. In addition, terms “include”, “comprise”, “contain”, or any other variations thereof are intended to cover non-exclusive inclusions, such that a process, a method, an article, or a device including a series of elements not only includes those elements, but also includes other elements that are not explicitly listed, or also includes inherent elements of the process, the method, the article, or the device. Without more restrictions, the elements defined by the sentence “including a . . . ” do not exclude the existence of other identical elements in the process, method, article, or device including the elements.

What are described above are only specific embodiments of the disclosure, such that those skilled in the art can understand or implement the disclosure. Various modifications to the examples are readily obvious to those skilled in the art, and the general principles defined herein can be implemented in other examples without departing from the spirit or scope of the 10 disclosure. Therefore, the disclosure is not limited to the examples shown herein but falls within the widest scope consistent with the principles and novel features disclosed herein.

1. A task processing method, comprising:
receiving editing information of a target task transmitted by a client of a first service type, wherein the editing information of the target task comprises: index information of the target task and editing data for modifying the target task;
determining a client of a second service type containing the target task according to the index information of the target task;
transmitting the editing information of the target task to the client of the second service type, to cause the client of the second service type to synchronously modify the target task; and
transmitting, in response to receiving editing information of a target task transmitted by the client of the second service type, the editing information of the target task to the client of the first service type, to cause the client of the first service type to synchronously modify the target task.

2. The method according to claim 1, wherein
the client of the first service type is an online document application client, and the client of the second service type is an instant messaging application client.

3. The method according to claim 2, wherein
in the client of the first service type, a document block is a minimum display unit of an online document, and one online document comprises one or more document blocks; and
the target task occupies one document block in the online document, and the document block only stores the index information of the target task.

4. A task processing method, comprising:
transmitting, in response to an opening request for a document of a client of a first service type, a first data obtaining request to a task server, wherein the first data obtaining request comprises: index information of a target task corresponding to a task type document block in the document;
receiving a first data obtaining response transmitted by the task server, wherein the first data obtaining response comprises: task content data corresponding to the index information of the target task; and
displaying, on the basis of the task content data corresponding to the index information of the target task, the task content data at a position of the task type document block in the document.

5. The method according to claim 4, further comprising:
transmitting, in response to an editing operation for task content data corresponding to index information of the target task of a client of a second service type, a data update request to the task server, wherein the data update request comprises: update content corresponding to the editing operation, to cause the task server to update the task content data corresponding to the index information of the target task.

6. The method according to claim 4, further comprising:
transmitting, in response to an editing operation for task content data corresponding to the index information of the target task in the document of the client of the first service type, a data update request to the task server, wherein the data update request comprises: update content corresponding to the editing operation, to cause the task server to update the task content data corresponding to the index information of the target task.

7. The method according to claim 4, further comprising:
transmitting, in response to an opening request for a task panel of the client of the second service type, a second data obtaining request to the task server, wherein the second data obtaining request comprises: index information of a target task comprised in the task panel;
receiving a second data obtaining response transmitted by the task server, wherein the second data obtaining response comprises: task content data corresponding to the index information of the target task; and
displaying, on the basis of the task content data corresponding to the index information of the target task, the task content data corresponding to the index information of the target task in the task panel.

8. The method according to claim 4, wherein the transmitting, in response to the opening request for the document of the first service type client, the first data obtaining request to the task server comprises:
obtaining, in response to the opening request for the document of the client of the first service type, the index information of the target task corresponding to the task type document block in the document from a document server, and transmitting the first data obtaining request to the task server.

9. The method according to claim 5, further comprising:
receiving, as the task type document block in the document is in an open state, the data update request transmitted by the task server, wherein the data update request comprises: update data, and the data update request is for requesting, at the document, updating and rendering the task type document block on the basis of the update data received.

10. The method according to claim 6, further comprising:
receiving, as a task panel in a client of a second service type is in an open state, the data update request transmitted by the task server, wherein the data update request comprises: update data, and the data update request is for requesting, at the task panel, updating and rendering the task type document block on the basis of the update data received.

11. The method according to claim 4, wherein in the client of the first service type, a document block is a minimum display unit of an online document, and one online document comprises one or more document blocks; and
the target task occupies one task type document block in the online document, and the task type document block only stores the index information of the target task.

12. (canceled)

13. (canceled)

14. An electronic device, comprising: a processor, wherein the processor is configured to execute a computer program stored in a memory, and when the computer program is executed by the processor, the processor is caused to:
transmit, in response to an opening request for a document of a client of a first service type, a first data obtaining request to a task server, wherein the first data obtaining request comprises: index information of a target task corresponding to a task type document block in the document;
receive a first data obtaining response transmitted by the task server, wherein the first data obtaining response comprises: task content data corresponding to the index information of the target task; and
display, on the basis of the task content data corresponding to the index information of the target task, the task content data at a position of the task type document block in the document.

15. (canceled)

16. (canceled)

17. The electronic device according to claim 14, further comprising:
transmitting, in response to an editing operation for task content data corresponding to index information of the target task of a client of a second service type, a data update request to the task server, wherein the data update request comprises: update content corresponding to the editing operation, to cause the task server to update the task content data corresponding to the index information of the target task.

18. The electronic device according to claim 14, further comprising:
transmitting, in response to an editing operation for task content data corresponding to the index information of the target task in the document of the client of the first service type, a data update request to the task server, wherein the data update request comprises: update content corresponding to the editing operation, to cause the task server to update the task content data corresponding to the index information of the target task.

19. The electronic device according to claim 14, further comprising:
transmitting, in response to an opening request for a task panel of the client of the second service type, a second data obtaining request to the task server, wherein the second data obtaining request comprises: index information of a target task comprised in the task panel;
receiving a second data obtaining response transmitted by the task server, wherein the second data obtaining response comprises: task content data corresponding to the index information of the target task; and
displaying, on the basis of the task content data corresponding to the index information of the target task, the task content data corresponding to the index information of the target task in the task panel.

20. The electronic device according to claim 14, wherein the transmitting, in response to the opening request for the document of the first service type client, the first data obtaining request to the task server comprises:
obtaining, in response to the opening request for the document of the client of the first service type, the index information of the target task corresponding to the task type document block in the document from a document server, and transmitting the first data obtaining request to the task server.

21. The electronic device according to claim 17, further comprising:
receiving, as the task type document block in the document is in an open state, the data update request transmitted by the task server, wherein the data update request comprises: update data, and the data update request is for requesting, at the document, updating and rendering the task type document block on the basis of the update data received.

22. The electronic device according to claim 18, further comprising:
receiving, as a task panel in a client of a second service type is in an open state, the data update request transmitted by the task server, wherein the data update request comprises: update data, and the data update request is for requesting, at the task panel, updating and rendering the task type document block on the basis of the update data received.

23. The electronic device according to claim 14, wherein in the client of the first service type, a document block is a minimum display unit of an online document, and one online document comprises one or more document blocks; and
the target task occupies one task type document block in the online document, and the task type document block only stores the index information of the target task.
